(19) United States
(12) Patent Application Publication
(10) Pub. No.: US 2010/0263005 A1
(43) Pub. Date: Oct. 14, 2010

(54) METHOD AND SYSTEM FOR EGNAGING INTERACTIVE WEB CONTENT

(76) Inventor: Eric Foster White, Littleton, CO (US)

Correspondence Address: Williams Mullen, Suite 1600, 200 South 10th St, Richmond, VA, 23218, US

(21) Appl. No.: 12/420,513

(22) Filed: Apr. 8, 2009

(51) Int. Cl. H04N 7/173; G06F 15/16; G06F 3/01

(52) U.S. Cl. 725/109; 709/206; 715/719

(57) ABSTRACT

The present invention engages interactive web content across a plurality of communication platforms including receiving an initiation request for viewing interactive web content across a first communication platform and determining profile information regarding a user's narrowcast identification information. If the profile information does not include the identification information, the method and system includes receiving the identification information directly from the user and beginning the interactive web content including distributing a video feed providing a video display to the user across the first communication platform. When the interactive web content reaches a first engagement point, generating a narrowcast communication directly to the user via a second communication platform based on the narrowcast identification information. In response to the narrowcast communication, the method and system includes receiving a first response from the user via the second communication platform and maintaining the interactive video display to the first user.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to methods and systems for engaging interactive multimedia, and more specifically, to engaging interactive web content across a plurality of communication platforms.

### BACKGROUND OF THE INVENTION

Internet and communication system developments have spawned a new age in the distribution of multimedia content. For example, with the explosion of user-generated content, professional digital media authors and content providers continue to push the envelope by enhancing digital media with rich animations via computer graphics, high-definition recording instruments and post-processing equipment. The web is trending towards more degrees of digital media distribution and interactivity.

As the availability of content increases, there are needs for advancement with interaction and interoperability. Due to the large scale of the Internet, it is difficult for content providers to engage a meaningful and interactive experience for the individual user. For example, with user-generated content, the interactive capability is limited by requiring the user to visit the website hosting the content. Currently, the extent of interactivity is the ability for a user to rank or post a comment about a content item or load content items onto the hosting site itself. Furthermore, to accomplish this task the user must log on to the website and interact with standardized forms. With professionally authored multimedia, the content is generally locked via digital rights management (DRM) technologies. DRMs inhibit interoperability, let alone provide for a meaningful interaction with a viewer.

In existing interactive web content, the user is presented with a single medium. For example, a user may interact with a web site or an application playing on the web site. One technique may be a video player (e.g. FLASH® player) where the user can engage the video display on the same medium, the Internet connection. This approach limits the user interaction to the single medium and fails to account for the availability of communication across multiple platforms.

Another area of concern that is not addressed by existing technology relates to the individualization of the interactive content. In a broadcast environment, the content is sent to all users, therefore there is no individualization of the content. Existing systems may allow for augmentation of the content based on knowledge of the viewer, such as ad-insertion in a network DVR environment, but the broadcast nature of the content restricts the content to being the same for all viewers.

As the Internet has evolved its media distribution capabilities, the media distribution has grown to include content broadcasting. A hallmark of Internet activity and functionality relates to user interaction and customization of the content to the viewer. Existing single-platform broadcast distributions fail, presenting the current need for multi-platform user customization and interactivity in a media content distribution.

### SUMMARY OF THE INVENTION

The present invention provides systems and methods for engaging interactive web content across a plurality of communication platforms. According to one embodiment, a method and system for engaging interactive web content across a plurality of communication platforms includes receiving, from a user, an initiation request for viewing interactive web content across a first communication platform, as well as determining profile information regarding the user, including narrowcast identification information for the user. If the profile information does not include the narrowcast identification information, the technique includes receiving the narrowcast identification information directly from the user. Having the narrowcast identification information, the technique includes performing the step of beginning the interactive web content including distributing a video feed providing a video display to the user across the first communication platform. When the interactive web content reaches a first engagement point, the technique performs the step of generating a narrowcast communication directly to the user via a second communication platform based on the narrowcast identification information. In response to the narrowcast communication, the technique performs the step of receiving a first response from the user via the second communication platform. During the step of generating a narrowcast message and receiving a reply, the method and system may maintain the interactive web content playing to the user or, if paused, the method and system may also perform the step of resuming the interactive video display to the first user based at least on the first reply.

According to another embodiment, determining the profile information for the user includes a secondary web location, for example, a social network web location. In addition, one embodiment includes a web-based platform and/or a text-messaging platform. The text messaging platform is operative to transmit a text message to a mobile communication device on a mobile communication platform. In other embodiments, the first and second communication platforms are the same.

According to another embodiment, the technique includes the step when the interactive web content reaches a second engagement point, generating a second narrowcast communication directly to the user via the second communication platform based on the narrowcast identification information, receiving a second response from the user via the second communication platform and maintaining the interactive video display to the first user based on the second response. In maintaining the interactive video display to the first user, one embodiment of the method for engaging interactive web content includes transmitting an ancillary communication to the user via the second communication platform, the ancillary communication including information based on a user profile. Maintaining the interactive web content may include various embodiments, such as continuing the display of the video content while narrowcast communications are being sent, or in another embodiment may include pausing the video while awaiting a response on a particular narrowcast communication.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for engaging interactive web content across a plurality of communication platforms;

FIG. 2 illustrates a flow diagram of the steps of one embodiment of a method for engaging interactive web content across a plurality of communication platforms;

FIG. 3 illustrates a sample screen shot of a video presentation across a first communication platform;

FIG. 4 illustrates a sample screen shot of a narrowcast message across a second communication platform;

FIG. 5 illustrates a flow diagram of the steps of another embodiment of a method for engaging interactive web content across a plurality of communication platforms;

FIG. 6 illustrates a flow diagram of the steps of another method of a method for engaging interactive web content across a plurality of communication platforms; and

FIG. 7 illustrates a block diagram of one embodiment of a system for engaging interactive web content across a plurality of communication platforms.

### DETAILED DESCRIPTION

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

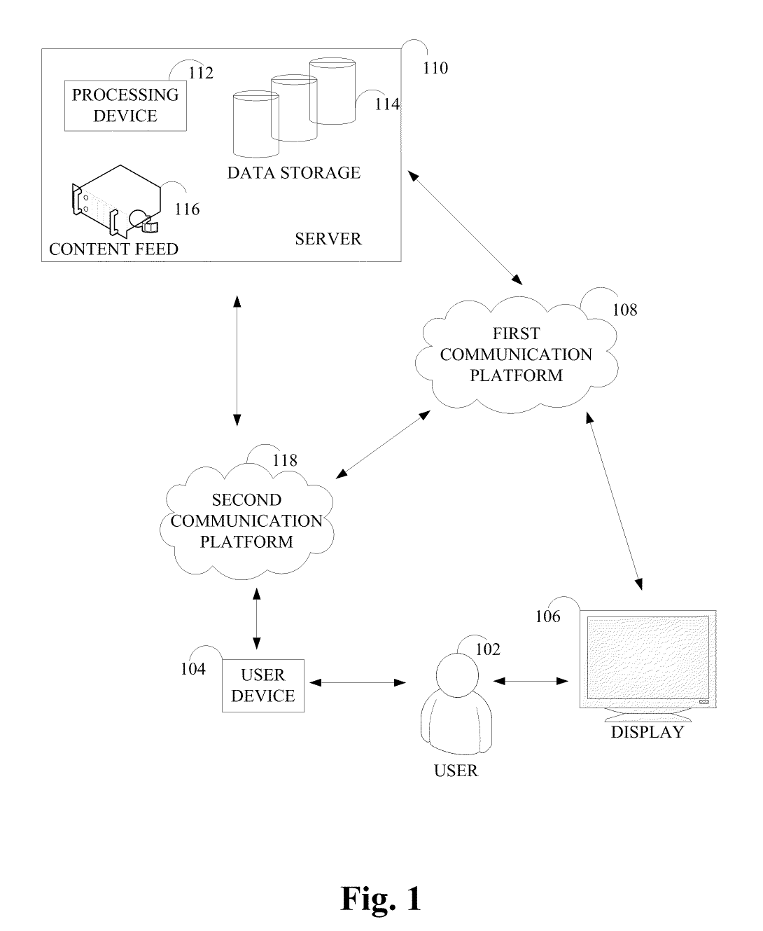

FIG. 1 illustrates a system 100 for engaging interactive web content across a plurality of communication platforms. The system 100 includes a user 102, a user device 104, a display 106, a first communication platform 108, a server 110 having a processing device 112, data storage 114 and a content feed 116, and a second communication platform 118.

In the interactive system 100, the user device 104 may be any suitable type of device, generally a combination of hardware and software, operable to be in communication with one or more communication platforms. The user device 104 may include a general-purpose computer comprising a processor or processing device with associated computer readable medium/memory, as recognized by one skilled in the art. The user device 104 may also include architecture for a plurality of input/output subsystems, at least one network adapter and bus to provide a communications path between components comprising the general purpose computer. The network adapter of the user device 104 may include a combination of hardware and software for communicating with a mobile platform, a wireless platform, a web-based or Internet platform, and the like. The user device 104 may be a cellular or mobile phone, a Smartphone, a personal digital assistant (PDA), or any other portable communication device communicating across the second communication platform 118.

The display 106 of the interactive system may be any suitable type of device, generally a combination of hardware and software, operative to receive and display a video feed from a communication platform. The display 106 may include a computer readable medium or other memory for storing and or playing a content stream, for example a video feed. In one embodiment, the display 106 may be a computer monitor providing display via a computer (not shown) engaged to the server 110 via the first communication platform 108, for example a browser application running on the computer being visible on the display 106.

The server 110 may comprise a computer or processing device on a network that manages network resources. As illustrated in FIG. 1, the server may include a processing device 112, data storage 114 and access to a content feed 116. According to one embodiment, the server 110 may include any number of servers such as an application server, an audio/video server, a database server, a fax server, a file server, an Intranet server, a mail server, a network access server, a proxy server, a remote access server, a telephony server or a web server. The server 110, user device 104, display 106 as well as the user 102 may all be in operable communication connected with bridging technologies such as Ethernet, a modem, a router and various network adapters. In another embodiment, the server 110 is a web server hosting a website. The user 102 may login and navigate to other areas of the website including a videos page, a votes page, a blog/live events page and community or social network page.

The processing device 112 may include a processor or CPU having an ALU, memory registers and input/output hardware architecture, as recognized by one skilled in the art. For example, a processor may include an instruction set, the set of instructions that the microprocessor can execute. In one embodiment, the server 110 may include a plurality of processing devices running in parallel.

The data storage 114 of the server 110 may include transient and persistent storage devices, such as a computer readable medium, Random Access Memory (RAM), cache memory, a hard drive or other computer memory. In one embodiment, the data storage 114 may include at least one database for storing information. The content feed 116 may include an audio/video server and multimedia server software for transmitting content such as a video feed, in accordance with known data feeding

In one embodiment, the system 100 may include the storage of any number of user profile information, such as a set of characteristics or attributes about the user or the user's environment. For example, a set of characteristics may include information regarding a user's age, gender, demographic information, content interest, historical web activity, user device information, and any other suitable type of information recognized by one skilled in the art. The storage of the profile information may be local in the system 100, e.g. stored in a database in the system 100 and the information is referenced using any suitable type of database access technique or routine. In another embodiment may be stored external to the system and can be referenced using a data call or communication share technique, one example being profile information stored on a social networking site and the system accessing the social networking site to determine the user profile information and specific user profile characteristics.

As shown in FIG. 1, the user 102 may engage interactive web content by transmitting and receiving messages to and from the server 110 via the first communication platform 108 and/or the second communication platform 118. Generally, a communication platform comprises a network of links and nodes arranged so that messages may be passed from one node to another over multiple links and through various nodes. The links and nodes of a network generally include a combination of physical materials and accepted protocols for establishing communication. For example, the Internet is a web-based network including physical devices (e.g., computer hardware and network devices) and standard protocols (e.g., TCP/IP) for establishing communication (e.g. sending messages through packets).

In one embodiment, the first communication platform 108 includes a web-based network. For example, the Internet, an Intranet, a local area network (LAN), wide area network (WAN) are web-based networks. As mentioned above, such web-based networks generally operate under known network models, using the TCP/IP protocol for transmitting packets at the transport and network layer.

When the first communication platform 108 is a web-based network, the application layer may include a plurality of protocols for managing and transmitting data to a specific user 102 via the user device 104. For example, some of the protocols available in a web-based network include the Hypertext Transfer Protocol (HTTP), a file transfer protocol, a wireless protocol, a secure shell protocol, a send mail transfer protocol, and a protocol for communicating with mobile devices, such as third generation “3G” and GSM, by way of example.

In one embodiment, the second communication platform 118 includes a cellular or mobile communication network. For example, the user device 104 may access a cellular or mobile network by connecting to a mobile network over the Global System for Mobile communications, the GSM standard. One implementation of a GSM network provides for a plurality of services to the user 102 through a base station subsystem, a network and switching subsystem and a global packet radio service (GPRS). When connected to a GSM network, the GPRS allows a user device 104 to communicate across the first communication platform, a web-based network, by establishing a connection through a network adapter and transmitting packet-based messages.

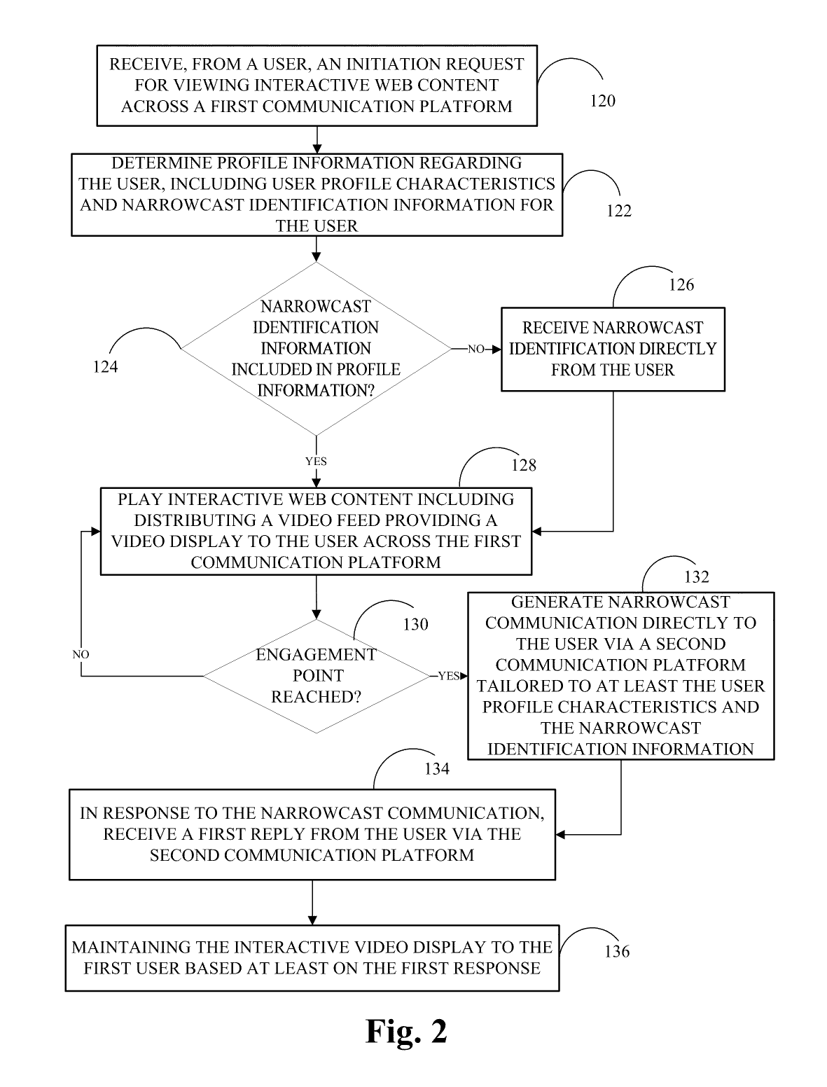

Various aspects of both platforms 108 and 118 have been omitted for clarity purposes only. The platforms 108 and 118 operate in accordance with known processing techniques for transmitting information thereacross, as recognized by one skilled in the art. Additionally, for the sake of brevity, various embodiments of the operations of the system 100 are described relative to the flowcharts of FIGS. 2 and 5-6.

FIG. 2 illustrates a flow diagram illustrating a method for engaging interactive web content across a plurality of communication platforms according to one embodiment. The method of FIG. 2 may include operational steps performed within the system 100 of FIG. 1.

The method includes, step 120, receiving, from a user, an initiation request for viewing interactive web content across a first communication platform. For example, this initiation request may be the user 102 accessing a particular web location on the Internet. The initiation request may be transmitted across the first communication platform 108, e.g. an Internet connection, to the server 110.

A next step, step 122, may be determining profile information regarding the user, including user profile characteristics and narrowcast identification information for the user. Narrowcast information includes information for providing an individually tailored communication. For example, narrowcast information may include user contact information as well as personal information. In one embodiment, narrowcast information may include a text message telephone number or other messaging service contact information. A narrowcast may be understood as a transmission of information that is limited to specific individual or group, generally referred to as subscriber(s). Distinct from a broadcast, where information is transmitted to the general public and available on any general receiver capable to capture the transmission signals, a narrowcast directs information to a particular audience.

A next step, step 124, includes the decision step to determine if the server 110 already has the proper narrowcast information. For example, the narrowcast information may be stored in a user profile, so when the user 102 engages the server 110, the user 102 is recognized by the server 110 and the profile information is associated with the user's activities on the web location. It is also recognized that the profile information may not be necessarily stored directly with the server 110 but may be accessible or referenced to another system. For example, the user 102 may reference a social networking location that includes the profile information.

In the method of FIG. 2, if the inquiry in step 124 is in the negative, meaning the narrowcast information is not included with the profile, a next step, step 126, is to receive narrowcast information directly from the user. This step may include a pop-up window on the display 106 asking the user 102 to enter narrowcast information, such as by way of example a mobile telephone number for receiving text messages.

If the inquiry in step 124 is in the affirmative or upon completion of step 126, a next step may be step 128, playing interactive web content including distributing a video feed providing a video display to the user across the first communication platform, step.

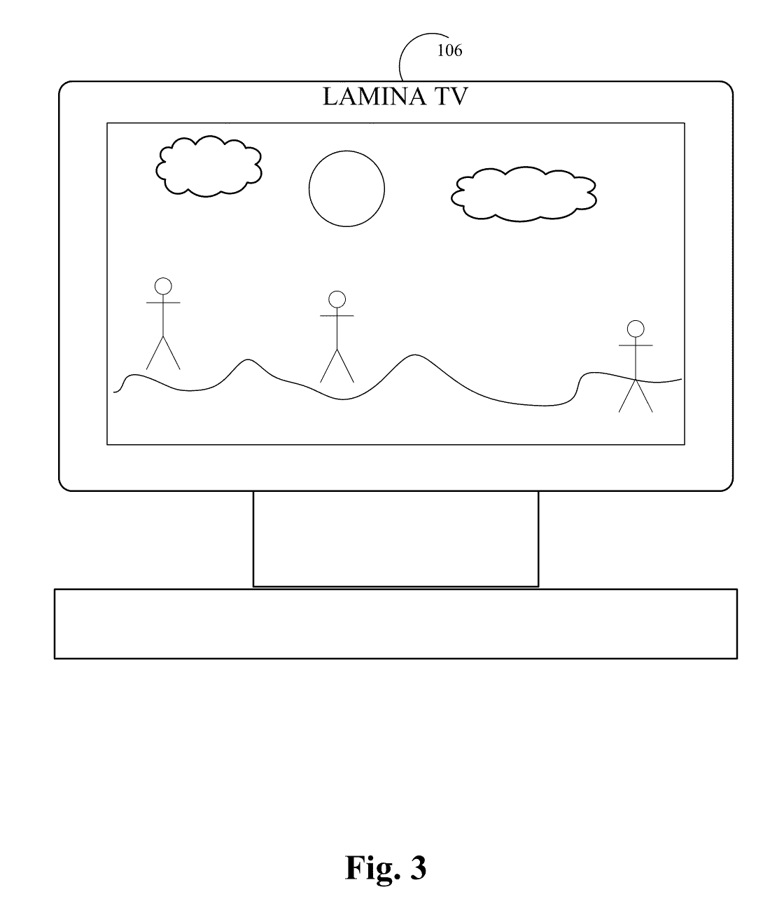

FIG. 3 illustrates a sample output screen of the display 106 illustrating an example of web content across the first communication platform. In this example, the image may be several characters having a discussion or some other type of scripted content. It is noted that the display is a narrowcast display to the user 102 (of FIG. 1) because this is an individualized display directed to the user via the user's engagement of the server 110. For example, any number of different users may engage the server from any number of different access points, each individual user receiving different video feeds, where it is noted the separate feeds may be of the same or similar content.

In the flowchart of FIG. 2, a next step is a determination step if the video has reached an engagement point, step 130. An engagement point may be a predetermined point in the interactive web content such that when the content reaches the noted point, the server 110 engages additional processing operations. If the engagement point has not been reached, the method iterates back to step 128.

Once the interactive web content reaches the engagement point, the method may perform the step of generating a narrowcast communication directly to the user via a second communication platform tailored to the user based at least on the user profile characteristics and on the narrowcast identification information, step 132. In one embodiment, this may include the transmission of a text message to the user device 104 of FIG. 1 via the second communication platform 118. In one embodiment, the narrowcast communication may include music (mp3), video content, simulated cast member text message, picture content, animation and/or a poll. The narrowcast communications mentioned above are exemplary only and not meant to be an exhaustive list, such that any other type of content as recognized by one skilled in the art may be included for narrowcast communication. In one embodiment, generating a narrowcast message may involve advertisers seeking to tailor a narrowcast communication to a specific set of users.

For example, an advertiser may want to generate one narrowcast communication directed to a specific demographic (e.g. males between the ages of 20 and 25) and generate a second narrowcast communication to a second specified demographic (e.g. females between the ages of 26 and 30). Advertisers may specify a set of user profile characteristics to accomplish the desired narrowcast tailoring. In the above example, a narrowcast may include sending one type of advertisement to a first user based on the first user's profile information and sending a completely different type of advertisement to the second user based on the second user's profile information. The embodiment where the narrowcast includes references the user profile information allows for the addition of even more narrowly tailored user-specific communications, providing additional benefit of personalization for the user and the system, but also adding an additional layer of customization for advertisers or other parties seeking direct communications to intended or targeted audiences in a more direct and efficient manner.

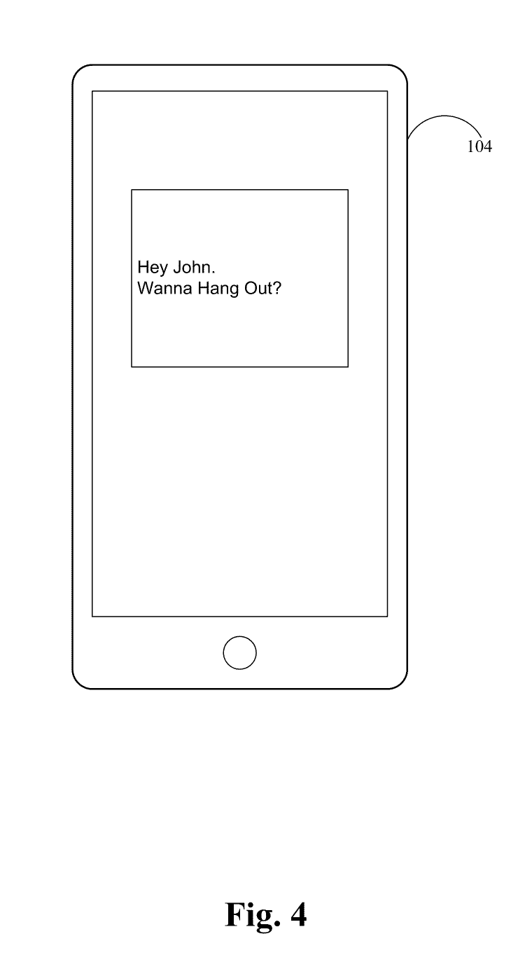

FIG. 4 illustrates an exemplary illustration of mobile device with receipt of a text message. In this example, the text message includes personalization information that may be tailored to the user, such as here illustrating the example of displaying the text message calling the user by his first name. In the overall system operation, the server 110 maintains the video playing via the first communication platform while engaging the second communication platform. In another embodiment, the server 110 may pause the video feed and wait for a reply from at least one user. For example, the video may conclude at the engagement point, awaiting a response from the user 102 across the second communication platform in order to proceed based on the response. By way of example, additional information may replace the video screen, such as ad content may temporarily replace the display while the user is engaged on the second platform. Using the exemplary text message of FIG. 4, the user 102 may respond by sending the message “no” or the message “yes” back to the server. In one embodiment, the user 102 may send and receive multimedia messages, including picture, animations and video messages. In yet another embodiment, the user may respond by sending a poll vote, an instruction to restart the paused video, provide additional user data and even enter a contest or sweepstakes. For example, one embodiment may include the web content being a video display of a competition between various individuals and the narrowcast communication including any number of communications being additional content from the users as well as a poll where the user can then cast a vote for a favorite competitor.

The method further includes receiving a first reply from the user via the second communication platform, step 134. As noted above, this may include the example of the user sending a text message, but it is recognized that any other suitable communication may be utilized, such as for example an electronic mail (email) message. The next step, step 136 is maintaining the interactive video display to the first user based on the reply. For example, if the user answers “yes” to the text message, the server 110 may then play a particular video or video segment via the first communication platform. If the user says “no,” the server 110 may play a different video or video segment. Therefore, the narrowcast video is interactive via the second communication platform, presenting to the user 102 video based on the second platform interactions.

Thereupon, in the embodiment illustrated in FIG. 2, the method is complete. It is recognized that further interaction engagements are possible via the two different platforms 108 and 118. The user 102 may view more video, receive additional narrowcast communications on the user device 104, respond and receive additional video content.

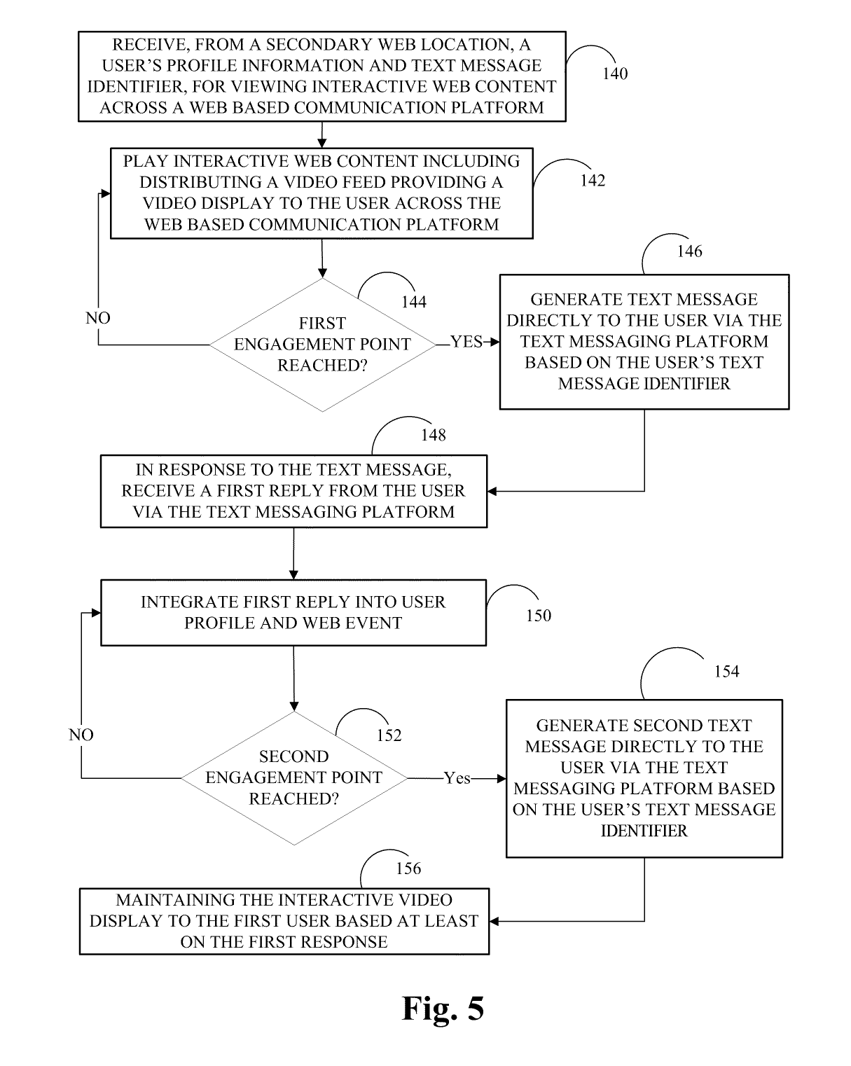

FIG. 5 illustrates a flow diagram illustrating a method for engaging interactive web content across a plurality of communication platforms according to another embodiment. The method includes, step 140, receiving, from a secondary web location, a user's profile information and text message identifier, for viewing interactive web content across a web based communication platform. The next step, step 142, is playing interactive web content including distributing a video feed providing a video display to the user across the web based communication platform. At step 144, the method determines if a first engagement point has been reached.

Once the interactive web content reaches the first engagement point, the method may perform the step of generating a text message directly to the user via a text-messaging platform based on the user's text message identifier, step 146. In response to the text message, the method may perform step 148, receiving a first reply from the user via the text-messaging platform. At step 150, the method may perform the step of maintaining the interactive video display to the first user based on at least the first reply. At step 152, the method decides whether a second engagement point has been reached. Once the method reaches that the second engagement point, the method may perform the step of generating a second text message directly to the user via a text-messaging platform based on the user's text message identifier, step 154. At step 156, the method performs the step maintaining the interactive video display to the first user based on at least the first reply.

The content of the distribution across either the first or second platform may include any number of forms of content. One example may be advertising associated with specific user content, such as a short commercial being aired with a video segment or an advertisement includes being included with a text message. Other examples may be loyalty program or reputation/status points, such as may be found on a social networking site. The content may be survey information, such as watching a video of performers and casting a vote of the preferred performer(s). The content may be a coupon or other sales-inducing content item for the user. The above-listed examples are exemplary only and not meant to be an exhaustive list, such that any other type of content as recognized by one skilled in the art may be included for narrowcast distribution. Thereupon, in the embodiment illustrated in FIG. 5, the method is complete.

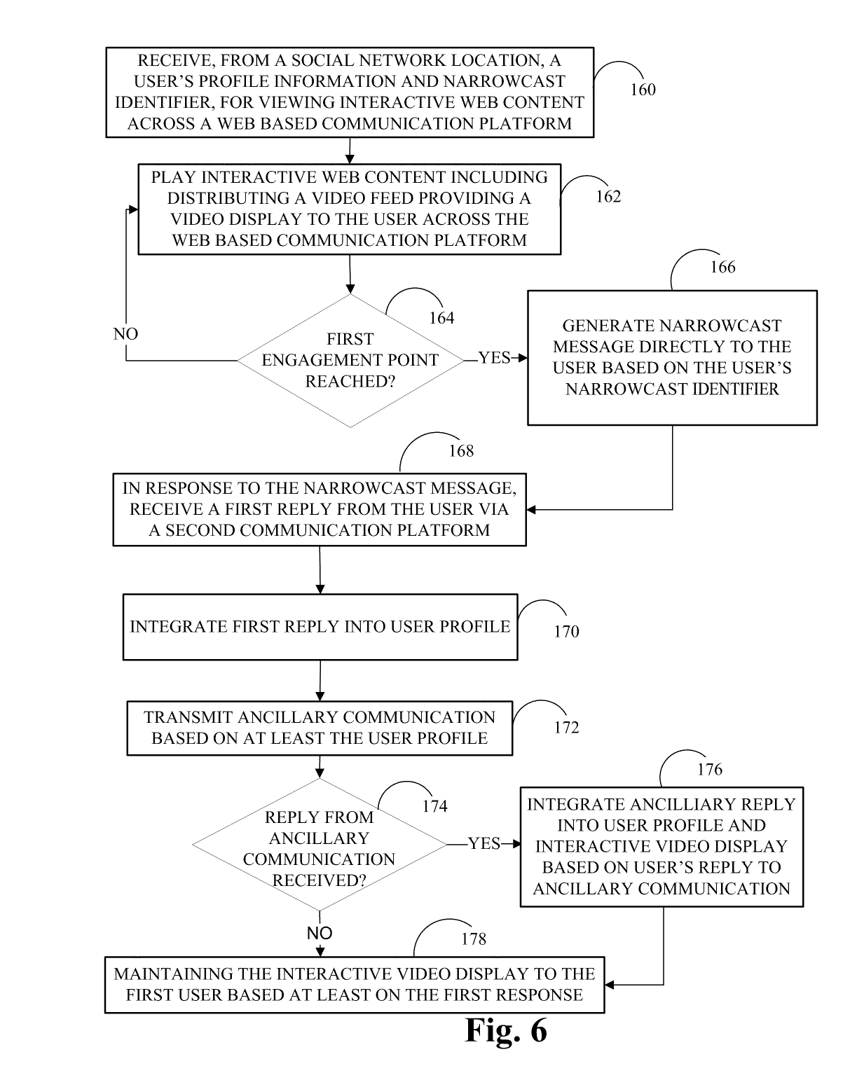

FIG. 6 illustrates a flow diagram illustrating a method for engaging interactive web content across a plurality of communication platforms according to another embodiment. The method includes, step 160, receiving, from a social network location, a user's profile information and narrowcast identifier, for viewing interactive web content across a web based communication platform. The next step, step 162, is playing interactive web content including distributing a video feed providing a video display to the user across the web based communication platform. At step 164, the method decides whether a first engagement point has been reached.

Once the interactive web content reaches the first engagement point, the method may perform the step of generating a narrowcast message directly to the user based on the user's narrowcast identifier, step 166. In response to the narrowcast message, the method may perform step 168, receiving a first reply from the user via a second communication platform. In one embodiment, the first reply from the user includes a GPS message identifying the location of the user. In another embodiment, the first reply from the user includes a vote associated with the video feed. At step 170, the method may perform the step of maintaining the interactive video display to the first user based on at least the first reply. At step 172, the method of FIG. 6 may perform the step of transmitting an ancillary communication based on at least the user profile. In one embodiment, the ancillary communication may comprise a digital transmission to a device associated with the user. In another embodiment, the ancillary message may comprise a digital transmission to a node within the user's social network. In yet another embodiment, the ancillary message may comprise a digital transmission based on the interactive content viewed by the user. In yet another embodiment, the digital transmission may comprise a digital transmission based on a reply received from the user.

At step 174, the method of FIG. 6 decides whether a reply from the ancillary communication was received. If a reply is received, the method may perform the step of integrating the ancillary reply into a user profile and interactive video display based on user's reply to ancillary communication. At step 176, the method performs the step of maintaining the interactive display. Thereupon, in the embodiment illustrated in FIG. 6, the method is complete.

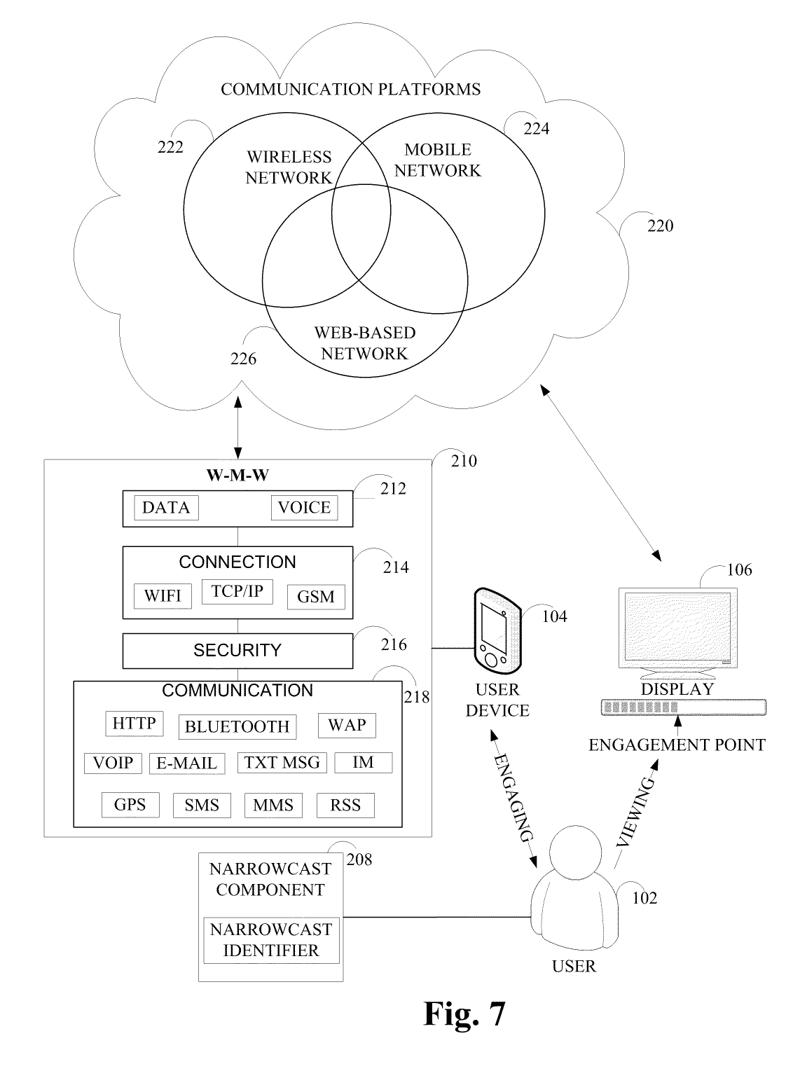

FIG. 7 illustrates a block diagram depicting a system for engaging interactive web content across a plurality of communication platforms according to another embodiment. The system of FIG. 7 includes the user 102, user device 104, display 106 showing an engagement point, and a narrowcast component 208 having a narrowcast identifier. The user device 104 may include a Wireless-Mobile-Web-Based “W-M-W” component 210 having a data/voice component 212, a connection component 214, a security component 216, and a communication component 218. The interactive system of FIG. 7 also includes a plurality of communication platforms 220. As illustrated, the plurality of communication platforms 220 includes a wireless network 222, a mobile network 224 and a web-based network 226.

As shown in the embodiment of FIG. 7, the user 102 is engaging with the user device 104 while viewing the display 106. The user 102 of FIG. 7 is also associated with a narrowcast component having a narrowcast identifier. The narrowcast component 208 may be operative to set the value of the narrowcast identifier. In one embodiment, the narrowcast component 208 sets the value of the narrowcast identifier to a unique string identifier associated with the user. In other embodiments, a narrowcast component may set the narrowcast identifier to a username identifier, a text message identifier, a mobile phone identifier, an Instant Message identifier, a BLUETOOTH® device identifier, a VOIP account identifier, a GPS chip identifier or a URL identifier. The narrowcast identifier uniquely identifies the user 102 by associating the user 102 with the user device 104. For example, where the user device 104 is a mobile phone, the narrowcast component 208 may set the narrowcast identifier to the mobile phone number associated with the user 102. In another embodiment, the user device 104 may include a portable media player where the narrowcast identifier is set to the username for the account associated with the user's media library manager. In yet another embodiment, the narrowcast component 208 may set the narrowcast identifier to a value including a combination of the above mentioned identifiers.

Irrespective of how the interactive system of FIG. 7 identifies the user 102, the system permits the user 102 to engage interactive web content by using any number of services. As shown in FIG. 7, the W-M-W component 210 of the user device 104 includes the components and modules for transmitting data and voice 212 transmissions over the plurality of communication platforms 220 where they may be received by a node on any given network. Also illustrated in FIG. 7 is the connection component 214. As depicted, the connection component 214 includes the modules for establishing communication with a wireless network 222, a mobile network 224 and a web-based network 226. The security component 216 of the user device 104 may include software for executing encryption algorithms, authentication processes and establishing secure connections.

The communication component 218 of FIG. 7 illustrates some of the available services that enable the user 102 to engage interactive web content. The services available on the user device 104 may include the use of protocols and standards such as HTTP, BLUETOOTH®, WAP, VOIP, E-mail, text messaging (TXT MSG), instant messaging (IM), GPS, SMS, MMS, and RSS. For example, the user device 104 may use HTTP to establish communication with devices on a web-based network 226. In another embodiment, the user device may use BLUETOOTH® to establish communication with a wireless network 222. BLUETOOTH® is a wireless protocol for exchanging data over short distances from fixed Internet, wireless and mobile devices, creating personal area networks (PANs). The user device 104 may include hardware, a BLUETOOTH® headset, or have a USB port for plugging in a BLUETOOTH® adapter. Similarly, the user device 104 may include hardware, a wireless adapter, or have a USB port for plugging in a wireless adapter. In addition, the Wireless Access Point (WAP) module shown in the communication component 218 may establish communication with other devices on a wireless network.

The communication component 218 includes a Voice-Over-Internet-Protocol (VOIP) module. VOIP is a general term for a family of transmission technologies for delivery of voice communications over IP networks such as the Internet or other packet-switched networks. As shown in FIG. 7, a user 102 may deliver voice and data through the user device 104 by using VOIP. The communication component 218 of the user device 104 may also include an e-mail application for sending and receiving e-mail messages and an application for sending instant messages (IMs). In addition, the communication component 218 may include a Short Message Service (SMS) for sending a text message. SMS is a communication service standardized for the GSM communication platform 224, using standardized communications protocols allowing the interchange of short text messages between mobile telephone devices.

The user device 104 may also use Multimedia Messaging Service (MMS), a telecommunications standard for sending messages that include multimedia objects such as images, audio, video, and/or rich text. In addition, the communication component 218 may include a Global Positioning System (GPS) chip for determining the location of the user device 104. Also shown as part of the communication component 218 is an RSS module for receiving RSS feeds. In the embodiment illustrated in FIG. 7, the plurality of communication platforms 220 overlap. This overlap represents the ability for a user device 104 to communicate across a plurality of platforms via the W-M-W component 210.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

FIGS. 1 through 7 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

What is claimed is:

1. A method for engaging interactive web content across a plurality of communication platforms, the method comprising:
receiving, from a user, an initiation request for viewing interactive web content across a first communication platform;
determining profile information regarding the user, including narrowcast identification information for the user;
if the profile information does not include the narrowcast identification information, receiving the narrowcast identification information directly from the user;
having the narrowcast identification information for the user, beginning the interactive web content including distributing a video feed providing a video display to the user across the first communication platform;
when the interactive web content reaches a first engagement point, generating a narrowcast communication directly to the user via a second communication platform based on the narrowcast identification information;
in response to the narrowcast communication, receiving a first response from the user via the second communication platform; and
maintaining the interactive video display to the first user based at least on the first response.

2. The method of claim 1 further comprising:
determining the profile information for the user from a secondary web location.

3. The method of claim 2, wherein the second web location is a social network web location.

4. The method of claim 1, wherein the first communication platform is a web-based communication platform.

5. The method of claim 1, wherein the second communication platform is a text-messaging platform.

6. The method of claim 5, wherein determining profile information includes:
determining user profile characteristics from a profile database; and
generating the narrowcast communication tailored to the user based at least on one or more of the user profile characteristics.

7. The method of claim 1, wherein the first communication platform is the same as the second communication platform.

8. The method of claim 1 further comprising:
when the interactive web content reaches a second engagement point, generating a second narrowcast communication directly to the user via the second communication platform based on the narrowcast identification information;
receiving a second response from the user via the second communication platform; and
maintaining the interactive video display to the first user based on the second response.

9. The method of claim 1 further comprising:
in maintaining the interactive video display to the first user, transmitting an ancillary communication to the user via the second communication platform, the ancillary communication including information based on the user viewing the interactive web content.

10. A system for engaging interactive web content across a plurality of communication platforms, the system comprising:
a computer readable medium having executable instructions stored thereon;
a processing device in communication with the computer readable medium operative to receive the executable instructions therefrom, the processing device, in response to the executable instructions, operative to:
receive, from a user, an initiation request for viewing interactive web content across a first communication platform;
determine profile information regarding the user, including narrowcast identification information for the user;
if the profile information does not include the narrowcast identification information, receive the narrowcast identification information directly from the user;
having the narrowcast identification information for the user, begin the interactive web content including distributing a video feed providing a video display to the user across the first communication platform;
when the interactive web content reaches a first engagement point, generate a narrowcast communication directly to the user via a second communication platform based on the narrowcast identification information;
in response to the narrowcast communication, receive a first response from the user via the second communication platform; and
maintain the interactive video display to the first user based at least on the first response.

11. The system of claim 10 wherein the processing device, in response to the executable instructions, is further operative to:
determine the profile information for the user from a secondary web location.

12. The system of claim 11, wherein the second web location is a social network web location.

13. The system of claim 10, wherein the narrowcast identification information is a text messaging identifier.

14. The system of claim 10, wherein the first communication platform is a web-based communication platform.

15. The system of claim 10, wherein the second communication platform is a text-messaging platform.

16. The system of claim 15, wherein the text-messaging platform includes the transmission of text messaging to a mobile communication device.

17. The system of claim 10, wherein the first communication platform is the same as the second communication platform.

18. The system of claim 10 wherein the processing device, in response to the executable instructions, is further operative to:
when the interactive web content reaches a second engagement point, generate a second narrowcast communication directly to the user via the second communication platform based on the narrowcast identification information;
receive a second response from the user via the second communication platform; and
maintain the interactive video display to the first user based on the second response.

19. The system of claim 10 wherein the processing device, in response to the executable instructions, further operative to:
in maintaining the interactive video display to the first user, transmit an ancillary communication to the user via the second communication platform, the ancillary communication including information based on the user viewing the interactive web content.

20. The system of claim 10 the processing device, when operative to determine profile information includes being operative to:
determine user profile characteristics from a profile database; and
generate the narrowcast communication tailored to the user based at least on one or more of the user profile characteristics.
